(19) United States
(12) Patent Application Publication
(10) Pub. No.: US 2019/0328008 A1
(43) Pub. Date: Oct. 31, 2019

(54) Taste Improvement for Stevia Sweetened Beverages with Miracle Fruit

(71) Applicant: The Coca-Cola Company, Atlanta, GA (US)

(72) Inventors: Juvenal Higiro, Atlanta, GA (US); Xiaoliang Tan, Atlanta, GA (US); You Chen, Atlanta, GA (US)

(21) Appl. No.: 16/349,814

(22) PCT Filed: Nov. 15, 2017
(86) PCT No.: PCT/US17/61786

§ 371 Date: May 14, 2019

Related U.S. Application Data
(60) Provisional application No. 62/423,158, filed on Nov. 16, 2016.

(51) Int. Cl. A23L 2/02; A23L 2/60; A23L 33/105; A23L 27/30

(52) U.S. Cl. CPC A23L 2/02; A23L 27/30; A23L 33/105; A23L 2/60

(57) ABSTRACT

A composition containing a stevia component, a miracle fruit component, and a beverage. A process of making a stevia sweetened beverage with miracle fruit.

### REFERENCE TO RELATED APPLICATION

This application claims the benefit of United States provisional application No. 62/423,158, filed Nov. 16, 2016, which is herein incorporated by reference in its entirety.

### FIELD OF THE INVENTION

The principles of the present invention relate generally to enhancing the taste of stevia sweetened beverages using miracle fruit.

### BACKGROUND OF THE INVENTION

Stevia is a no calorie sweetener that is extracted from the leaves of the plant species Stevia rebaudiana. However, common problems associated with the use of stevia and stevia based products as a sweetener are a bitterness and lingering aftertaste. These problems can be even more problematic when the stevia sweetener is used at higher concentrations. Because of the bitterness and lingering aftertaste associated with stevia use, there has been a barrier to a broader application of stevia in zero or low calorie beverages. Consumers have often criticized beverages sweetened with stevia because of the bitterness and after tastes issues. Some have attempted to address the bitterness and lingering aftertaste issues using flavor modulators, but most flavor modulators are expensive and tend to change the flavor profile of the beverage, even when used at low concentrations. Additionally, many of these flavor modulators are artificial, which makes them unfavorable to certain consumers.

Miracle fruit or miracle berry is a plant, Synsepalum dulcificum, found in West Africa. The pulp of the miracle fruit contains a protein known as “miraculin,” which has the ability to bind to taste receptors on the human tongue, thereby causing humans to perceive sour or bitter foods as tasting sweet. Miracle fruit tablets are commercially available as supplements in some regions. Such miracle fruit tablets are chewed by consumers before consuming sour or bitter beverages or foods. The consumer then experiences those sour beverages or foods as tasting sweet. However, when consuming the tablets, consumers often experience perceiving everything as tasting sweet for several hours after consuming the tablets, which is generally undesirable.

In order for stevia-sweetened beverages to become more widely accepted and enjoyed by larger groups of consumers, there is a need for a natural modulator that will reduce or eliminate the bitterness and lingering aftertaste without impacting the flavor profile of beverages sweetened with stevia.

### BRIEF SUMMARY OF THE INVENTION

One aspect of the present disclosure is the provision of compositions containing a stevia component, a miracle fruit component, and a beverage. In certain embodiments, the stevia component is selected from stevioside, rebaudioside A, rebaudioside B, rebaudioside C, rebaudioside D, rebaudioside E, and rebaudioside F, rebaudioside O, rebaudioside N, rebaudioside I, rebaudioside M, rubusoside, steviolbioside, dulcoside A, and combinations thereof. The miracle fruit component contains miraculin. In yet further embodiments, the miracle fruit component is miracle fruit pulp powder, fresh miracle fruit pulp, frozen miracle fruit pulp, concentrated miracle fruit pulp, or is from synthetic sources. In still further embodiments, the beverage is a soda, flavored water (still or carbonated), tea, coffee, or fruit juice. Other beverages are contemplated.

Another aspect of the present disclosure is the provision of a method of making a stevia sweetened miracle fruit beverage. The method may include supplying a beverage, supplying a miracle fruit component, supplying a stevia component and combining the beverage, miracle fruit component, and stevia component to produce a stevia sweetened miracle fruit beverage. In further embodiments, the miracle fruit component is powdered miracle fruit component and the method further includes dissolving the miracle fruit component in water before supplying the miracle fruit component. In certain embodiments of the method, the stevia component is selected from stevioside, rebaudioside A, rebaudioside B, rebaudioside C, rebaudioside D, rebaudioside E, and rebaudioside F, rebaudioside O, rebaudioside N, rebaudioside I, rebaudioside M, rubusoside, steviolbioside, dulcoside A, and combinations thereof. In yet further embodiments of the method, the miracle fruit component is miracle fruit pulp powder, fresh miracle fruit pulp, frozen miracle fruit pulp, concentrated miracle fruit pulp, or from synthetic sources. In still further embodiments of the method, the beverage is a soda, flavored water (still or carbonated), tea, coffee, or fruit juice.

A person of ordinary skill in the art would understand that the concentrations of the various components can vary depending on the addition, substitution, and/or subtraction of ingredients in a given composition.

### DETAILED DESCRIPTION OF THE INVENTION

One aspect of the present disclosure is the provision of compositions containing a stevia component, a miracle fruit component, and a beverage, and methods of making the same.

According to certain embodiments, the stevia component can be any stevia compound or derivative, including but not limited to Pure Circle SG 95 (available from Tereos), Pure Circle Reb-A (available from Tereos), Pure Circle Reb-M (available from Tereos), Pure Circle Alpha (available from Tereos), and other steviol glycosides products. Steviol glycosides that can be used in certain embodiments may include stevioside, rebaudioside A, rebaudioside B, rebaudioside C, rebaudioside D, rebaudioside E, and rebaudioside F, rebaudioside O, rebaudioside N, rebaudioside I, rebaudioside M, rubusoside, steviolbioside, and dulcoside A. The stevia component, in some embodiments, can include combinations of more than one stevia compound or derivative.

The use of stevia based sweeteners is favored by certain groups of consumers, including those desiring more natural-based sweeteners and those seeking a low glycemic diet. Stevia does not induce a glycemic response when ingested, thus making stevia a favorable sweetener for diabetics and those on carbohydrate controlled diets. Beverages produced in accordance with embodiments described herein may be favored by consumers seeking a low glycemic or low carbohydrate diet, consumers who are diabetic, and those who are seeking to control their caloric consumption. Beverages in accordance with certain embodiments may be diet beverages, weight loss beverages, low carbohydrate beverages, diabetic beverages, and dietary supplement beverages.

In particular embodiments, the beverage can be selected from any beverage that could be sweetened with stevia. Such beverages include flavored waters (both still and carbonated), sodas, fruit juice, coffees, and teas. The fruit juices can be any fruit juices, including smoothies, citrus fruit juice (such as orange juice, lemon juice, lime juice, kumquat juice, tangerine juice, grapefruit juice, and combinations thereof), berry based fruit juices, cranberry juice, and so forth.

The concentrations of stevia component and miracle fruit component may be different for different beverages. A person of skill in the art may understand how to select appropriate concentrations of stevia component and miracle fruit component to achieve a desired taste perception for consumers. Such desired taste perceptions will include perceiving the beverage as tasting sweet while not experiencing the lingering bitterness and aftertaste typically associated with stevia. Additionally, according to some embodiments, the consumer does not experience a lingering impact oftentimes associated with miracle fruit tablet consumption, i.e., the consumer will not perceive items consumed after the beverage has been consumed as tasting sweet, as a result of an appropriate concentration of the miracle fruit component relative to the stevia component.

In some embodiments, when using powdered miracle fruit pulp, the desired final concentration of miracle fruit pulp powder may range from about 0.005% to 2.0% by weight of the final product. In further embodiments, the desired final concentration of miracle fruit pulp powder may range from about 0.005% to 0.01% of the final product. In further embodiments, the desired final concentration of miracle fruit pulp powder may range from about 0.01% to 0.2% of the final product. In further embodiments, the desired final concentration of miracle fruit pulp powder may range from about 0.5% to 1.0% of the final product. In further embodiments, the desired final concentration of miracle fruit pulp powder may range from about 1.0% to 1.5% of the final product. In further embodiments, the desired final concentration of miracle fruit pulp powder may range from about 1.5% to 2.0% of the final product. In some embodiments, the concentration of miracle fruit pulp powder may be about 0.005% of the final product. In some embodiments, the concentration of miracle fruit pulp powder may be about 0.01% of the final product. In some embodiments, the concentration of miracle fruit pulp powder may be about 0.02% of the final product. In some embodiments, the concentration of miracle fruit pulp powder may be about 0.03% of the final product. In some embodiments, the concentration of miracle fruit pulp powder may be about 0.04% of the final product. In some embodiments, the concentration of miracle fruit pulp powder may be about 0.05% of the final product. In some embodiments, the concentration of miracle fruit pulp powder may be about 0.06% of the final product. In some embodiments, the concentration of miracle fruit pulp powder may be about 0.07% of the final product. In some embodiments, the concentration of miracle fruit pulp powder may be about 0.08% of the final product. In some embodiments, the concentration of miracle fruit pulp powder may be about 0.09% of the final product. In some embodiments, the concentration of miracle fruit pulp powder may be about 0.1% of the final product. In some embodiments, the concentration of miracle fruit pulp powder may be about 0.2% of the final product. In some embodiments, the concentration of miracle fruit pulp powder may be about 0.3% of the final product. In some embodiments, the concentration of miracle fruit pulp powder may be about 0.4% of the final product. In some embodiments, the concentration of miracle fruit pulp powder may be about 0.5% of the final product. In some embodiments, the concentration of miracle fruit pulp powder may be about 0.6% of the final product. In some embodiments, the concentration of miracle fruit pulp powder may be about 0.7% of the final product. In some embodiments, the concentration of miracle fruit pulp powder may be about 0.8% of the final product. In some embodiments, the concentration of miracle fruit pulp powder may be about 0.9% of the final product. In some embodiments, the concentration of miracle fruit pulp powder may be about 1.0% of the final product. In some embodiments, the concentration of miracle fruit pulp powder may be about 1.1% of the final product. In some embodiments, the concentration of miracle fruit pulp powder may be about 1.2% of the final product. In some embodiments, the concentration of miracle fruit pulp powder may be about 1.3% of the final product. In some embodiments, the concentration of miracle fruit pulp powder may be about 1.4% of the final product. In some embodiments, the concentration of miracle fruit pulp powder may be about 1.5% of the final product. In some embodiments, the concentration of miracle fruit pulp powder may be about 1.6% of the final product. In some embodiments, the concentration of miracle fruit pulp powder may be about 1.7% of the final product. In some embodiments, the concentration of miracle fruit pulp powder may be about 1.8% of the final product. In some embodiments, the concentration of miracle fruit pulp powder may be about 1.9% of the final product. In some embodiments, the concentration of miracle fruit pulp powder may be about 2.0% of the final product. Although the percentages provided above are expressed in “by weight” values, one of ordinary skill in the art would understand that the percentages may be determined and expressed in “by volume” values.

In some embodiments, when using fresh or frozen miracle fruit pulp, the desired final concentration of the fresh or frozen miracle fruit pulp may range from about 0.025% to 5% of the final product. In further embodiments, the desired final concentration of miracle fruit pulp powder may range from about 0.05% to 1% of the final product. In further embodiments, the desired final concentration of miracle fruit pulp powder may range from about 0.025% to 0.05% of the final product. In further embodiments, the desired final concentration of miracle fruit pulp powder may range from about 1.0% to 2.0% of the final product. In further embodiments, the desired final concentration of miracle fruit pulp powder may range from about 2.0% to 3.0% of the final product. In further embodiments, the desired final concentration of miracle fruit pulp powder may range from about 3.0% to 4.0% of the final product. In further embodiments, the desired final concentration of miracle fruit pulp powder may range from about 4.0% to 5.0% of the final product. In some embodiments, the concentration of fresh or frozen miracle fruit pulp may be about 0.025% of the final product. In some embodiments, the concentration of fresh or frozen miracle fruit pulp may be about 0.05% of the final product. In some embodiments, the concentration of fresh or frozen miracle fruit pulp may be about 0.075% of the final product. In some embodiments, the concentration of fresh or frozen miracle fruit pulp may be about 0.1% of the final product. In some embodiments, the concentration of fresh or frozen miracle fruit pulp may be about 0.2% of the final product. In some embodiments, the concentration of fresh or frozen miracle fruit pulp may be about 0.3% of the final product. In some embodiments, the concentration of fresh or frozen miracle fruit pulp may be about 0.4% of the final product. In some embodiments, the concentration of fresh or frozen miracle fruit pulp may be about 0.5% of the final product. In some embodiments, the concentration of fresh or frozen miracle fruit pulp may be about 0.6% of the final product. In some embodiments, the concentration of fresh or frozen miracle fruit pulp may be about 0.7% of the final product. In some embodiments, the concentration of fresh or frozen miracle fruit pulp may be about 0.8% of the final product. In some embodiments, the concentration of fresh or frozen miracle fruit pulp may be about 0.9% of the final product. In some embodiments, the concentration of fresh or frozen miracle fruit pulp may be about 1% of the final product. In some embodiments, the concentration of fresh or frozen miracle fruit pulp may be about 1.5% of the final product. In some embodiments, the concentration of fresh or frozen miracle fruit pulp may be about 2.0% of the final product. In some embodiments, the concentration of fresh or frozen miracle fruit pulp may be about 2.5% of the final product. In some embodiments, the concentration of fresh or frozen miracle fruit pulp may be about 3.0% of the final product. In some embodiments, the concentration of fresh or frozen miracle fruit pulp may be about 3.5% of the final product. In some embodiments, the concentration of fresh or frozen miracle fruit pulp may be about 4.0% of the final product. In some embodiments, the concentration of fresh or frozen miracle fruit pulp may be about 4.5% of the final product. In some embodiments, the concentration of fresh or frozen miracle fruit pulp may be about 5.0% of the final product.

According to embodiments described herein, the miracle fruit component contains miraculin. In particular embodiments, the miracle fruit component is selected from miracle fruit pulp powder, fresh miracle fruit pulp, frozen miracle fruit pulp, and miracle fruit pulp concentrates. In still further embodiments, the miraculin may be obtained from synthetic sources. Various sources of miracle fruit are available. As described herein, the miracle fruit component may be any form that includes miraculin that is derived from pulp of miracle fruit. A person of skill in the art will understand that the source of the miracle fruit component may be selected based on the desired preparation method or beverage. The source of the miracle fruit component may also be indicative of the method to be used for preparation of the compositions. For instance, if one desires to add the miracle fruit component directly to the an enhanced water beverage, one may select a very fine miraculin powder or synthetic source of miraculin, such that it may be dissolved directly into the enhanced water beverage without causing discoloration or granularity/particulates. Similarly, if miracle fruit pulp concentrate is utilized, the concentrate may need to be diluted with water or other liquid. Then, additional processing of the diluted concentrated, such as by centrifuging, may be used to remove particulate or granular matter that would not be desired by the consumer.

In some embodiments, the miracle fruit component may be a miracle fruit pulp powder that is obtained by freeze-drying miracle fruit pulp. In such embodiments, the miracle fruit component is obtained by dissolving the miracle fruit pulp powder in a liquid (such as water, fruit juice, or other selected beverage or liquid) to produce a liquid phase containing miraculin. The resulting liquid phase may be then added to the stevia sweetened beverage. In further embodiments, the resulting liquid phase may be added to the beverage before a stevia component is added to the beverage. In some embodiments, particulates or solids may be removed using known methods, such as centrifuging, from the liquid phase before it is added to the beverage. The resulting stevia sweetened miracle fruit beverage is then perceived by the consumer as lacking the bitter and lingering after taste typically associated with stevia. Moreover, the stevia sweetened miracle fruit beverage may be perceived by the consumer as being sweeter without the added calories of an additional sweetener, such as sugar, or other calorie-laden sweeteners. Additionally, in yet further embodiments, the consumer does not experience a continued sweetened taste related to the miracle fruit component after consuming the composition that is typically experienced by an individual consuming miracle fruit tablets.

Another aspect of the present disclosure is the provision of a method of making a stevia sweetened miracle fruit beverage. The process may include supplying a beverage, supplying a miracle fruit component, supplying a stevia component and combining the beverage, miracle fruit component, and stevia component to produce a stevia sweetened miracle fruit beverage. The order of addition of the various components may be varied based on the stevia component, beverage, and miracle fruit component selected. For instance, in some embodiments, the miracle fruit component is powdered miracle fruit component and the process further includes dissolving the miracle fruit component in water or other liquid before the step of supplying the miracle fruit component. In yet further embodiments, the miracle fruit component may be added directly to the beverage.

Embodiments may achieve satisfactory taste modulation on stevia sweetened beverages without a change in the flavor profile that otherwise characterizes most flavor modulators. Additionally, the compositions described herein do not require consumers to chew the miracle fruit tablet, and, according to certain embodiments, the consumers do not experience the lingering sweet taste perception typically experienced by consumers after consuming a miracle fruit tablet.

In some embodiments, numbers expressing quantities of ingredients, properties, such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

All publications, patents, patent applications, and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1: Compound Preparation

Miracle fruit pulp powder from fresh crop was ordered from Miracle Fruit Farm located in Miami, Florida. To prepare the miracle fruit component containing miraculin, a 10% solution of the freeze-dried powder was made using filtered water at ambient temperature. The solution was agitated for 1 hour. After 1 hour, the solution was thick, but pourable. The solution was then centrifuged using a Beckman Coulter Allegra 25 R centrifuge, at 3600 RPM for 5 minutes with temperature control at ambient temperature. The resulting supernatant containing miraculin was then collected.

### Example 2: Mock Beverage Preparation

The following Table 1 shows the ingredients and their corresponding amounts in the mock beverage samples that were prepared using the supernatant prepared in Example 1. Rebaudioside-A (>95% purity) was used to sweeten the beverages as shown in Table 1.

TABLE 1
Mock Beverage Samples

| | Control | Test Sample | Test Sample | Test Sample |
|---|---|---|---|---|
| | Sample | 1 | 2 | 3 |
| Ingredients | Amount (g) | Amount (g) | Amount (g) | Amount (g) |
| Filtered water | 99.81 | 99.56 | 99.31 | 99.06 |
| Citric acid | 0.117 | 0.117 | 0.117 | 0.117 |
| Sodium citrate | 0.027 | 0.027 | 0.027 | 0.027 |
| Miracle fruit | — | 0.25 | 0.5 | 0.75 |
| component | | | | |
| Reb-A | 0.05 | 0.05 | 0.05 | 0.05 |
| TOTAL | 100 g | 100 g | 100 g | 100 g |

The miracle fruit component amounts in Test Samples 1, 2, and 3 correspond to 250 ppm, 500 ppm, and 750 ppm of the powder, respectively.

The following Table 2 shows the ingredients and their corresponding amounts in the mock enhanced water samples.

TABLE 2
Enhanced Water Samples

| | Control | Test Sample | Test Sample | Test Sample |
|---|---|---|---|---|
| | Sample | 1 | 2 | 3 |
| Ingredients | Amount (g) | Amount (g) | Amount (g) | Amount (g) |
| Filtered water | 99.675 | 99.55 | 99.525 | 99.5 |
| Citric acid | 0.096 | 0.096 | 0.096 | 0.096 |
| Ascorbic acid | 0.045 | 0.045 | 0.045 | 0.045 |
| Mineral & | 0.047 | 0.047 | 0.047 | 0.047 |
| vitamin | | | | |
| premix | | | | |
| Natural color | 0.068 | 0.068 | 0.068 | 0.068 |
| Natural berry | 0.049 | 0.049 | 0.049 | 0.049 |
| flavor | | | | |
| Reb-A | 0.019 | 0.019 | 0.019 | 0.019 |
| Miracle fruit | — | 0.125 | 0.15 | 0.175 |
| component | | | | |
| TOTAL | 100 g | 100 g | 100 g | 100 g |

The miracle fruit component amounts in Test Samples 1, 2, and 3 correspond to 125 ppm, 150 ppm, and 175 ppm of the powder, respectively.

The miracle fruit component was added to the mock beverage and enhanced water samples and stirred for 30 minutes. The beverages were filled in 400 ml-PET bottles. The beverages were pasteurized using in-bottle pasteurization using a Miele Professional® (Miele, Princeton, N.J.) washer with temperature and time control at 80° C. for 15 minutes. The mock beverage and mock enhanced water samples were then cooled down being stored in a refrigerator.

### Example 3: Sensory Evaluation of Stevia Sweetened Beverages With Miracle Fruit

The beverages prepared in Example 2 were evaluated blindly by an expert panel of six individuals. Cold samples were coded and randomly presented to the panelists in 100 ml-opaque cups. Panelists were instructed to eat an unsalted cracker and rinse their mouth with mineral water before and in between samples. For each sample, panelists were instructed to take three sips, then write down their evaluation comments. The control sample was tasted first, followed by the test samples.

TABLE 3
Mock Beverage with Miracle Fruit

| | | Concentration | |
|---|---|---|---|
| | | of Miracle fruit | |
| Mock Beverage | Reb-A | in Beverage | |
| Samples | (ppm) | (ppm) | Panelists Comments |
| Control Sample | 500 | — | Too much sweet lingering and |
| | | | bitter aftertaste |
| Test Sample 1 | 500 | 250 | Sweet lingering and bitterness |
| | | | are slightly reduced compared |
| | | | to the control |
| Test Sample 2 | 500 | 500 | Sweet linger and bitter |
| | | | aftertaste are much reduced, |
| | | | preferred by panelists |
| Test Sample 3 | 500 | 750 | Sweet linger and bitter |
| | | | aftertaste reduction but there |
| | | | is presence of berry notes |

TABLE 4
Enhanced Water with Miracle Fruit

| | | Concentration | |
|---|---|---|---|
| | | of Miracle fruit | |
| Enhanced Water | Reb-A | in Beverage | |
| Samples | (ppm) | (ppm) | Panelists Comments |
| Control Sample | 190 | — | Too much sweet linger and |
| | | | bitter aftertaste |
| Test Sample 1 | 190 | 125 | Sweet lingering and |
| | | | bitterness are slightly |
| | | | reduced compared to the |
| | | | control |
| Test Sample 2 | 190 | 150 | Sweet linger and bitter |
| | | | aftertaste are much reduced, |
| | | | preferred by panelists |
| Test Sample 3 | 190 | 175 | Sweet linger and bitter |
| | | | aftertaste reduction but the |
| | | | overall flavor profile |
| | | | changed |

The panelists' comments above on both the mock beverage samples and the enhanced water samples demonstrate that the miracle fruit component improved the stevia-sweetened beverages by reducing the sweet linger and the bitter aftertaste, which are attributes most disliked by consumers. Additionally, no consumers reported lingering perceived sweetness that is typically associated with consuming miracle fruit tablets. Notably, for both the mock beverage and mock enhanced water, the expert panel preferred the middle concentration of miracle fruit, thus showing an optimization of concentration of miracle fruit can be achieved such that consumers experience the benefits of perceived sweetness of the miracle fruit extract, without the bitterness and lingering aftertaste associated with stevia and also without lingering perceived sweetness as is typical of miracle fruit tablets.

As various modifications could be made in the compositions and methods herein described without departing from the scope of the invention, it is intended that all matter contained in the foregoing description shall be interpreted as illustrative rather than limiting. The breadth and scope of the present invention should not be limited by any of the above-described exemplary embodiments, but should be defined only in accordance with the following claims appended hereto and their equivalents. All patent and non-patent documents cited in this specification are incorporated herein by reference in their entireties.

1. A composition comprising:
a stevia component;
a miracle fruit component; and
a beverage.

2. The composition of claim 1 wherein the stevia component is selected from stevioside, rebaudioside A, rebaudioside B, rebaudioside C, rebaudioside D, rebaudioside E, and rebaudioside F, rebaudioside O, rebaudioside N, rebaudioside I, rebaudioside M, rubusoside, steviolbioside, dulcoside A, and combinations thereof.

3. The composition of claim 1, wherein the miracle fruit component is miracle fruit pulp powder.

4. The composition of claim 3, wherein the miracle fruit pulp powder is about 0.005% to 2% of the composition.

5. The composition of claim 3, wherein the miracle fruit pulp powder is about 0.01% to 0.2% of the composition.

6. The composition of claim 1, wherein the miracle fruit component is fresh miracle fruit pulp.

7. The composition of claim 6, wherein the fresh miracle fruit pulp is about 0.025% to 5% of the composition.

8. The composition of claim 6, wherein the fresh miracle fruit pulp is about 0.05% to 1% of the composition.

9. The composition of claim 1, wherein the miracle fruit component is frozen miracle fruit pulp.

10. The composition of claim 9, wherein the frozen miracle fruit pulp is about 0.025% to 5% of the composition.

11. The composition of claim 9, wherein the frozen miracle fruit pulp is about 0.05% to 1% of the composition.

12. The composition of claim 1, wherein the beverage is soda.

13. The composition of claim 1, wherein the beverage is flavored water.

14. The composition of claim 1, wherein the beverage is tea.

15. The composition of claim 1, wherein the beverage is coffee.

16. The composition of claim 1, wherein the beverage comprises fruit juice.

17. The composition of claim 1, wherein the fruit juice is selected from orange juice, lemon juice, lime juice, kumquat juice, tangerine juice, grapefruit juice, and combinations thereof.

18. The composition of claim 1, wherein the miracle fruit component is from synthetic sources.

19. A method of making a stevia sweetened miracle fruit beverage, the method comprising:
supplying a beverage;
supplying a miracle fruit component;
supplying a stevia component; and
combining the beverage, miracle fruit component, and stevia component to produce a stevia sweetened miracle fruit beverage.

20. The method of claim 19, further wherein supplying a miracle fruit component includes supplying a powdered miracle fruit component, and further comprising dissolving the miracle fruit component in water before supplying the miracle fruit component.

21. The method of claim 19, wherein supplying a miracle fruit component includes supplying a miracle fruit component that is frozen miracle fruit pulp.

22. The method of claim 19, further wherein the miracle fruit component is fresh miracle fruit pulp.

23. The method of claim 19, wherein supplying a beverage includes supplying a beverage selected from soda, flavored water, tea, coffee, fruit juice, and combinations thereof.

24. The method of claim 19, further comprising supplying a stevia component selected from stevioside, rebaudioside A, rebaudioside B, rebaudioside C, rebaudioside D, rebaudioside E, and rebaudioside F, rebaudioside O, rebaudioside N, rebaudioside I, rebaudioside M, rubusoside, steviolbioside, dulcoside A, and combinations thereof.

25. The method of claim 19, wherein supplying a miracle fruit component includes supplying a miracle fruit component that is from synthetic sources.
